(19) United States
(12) Patent Application Publication
(10) Pub. No.: US 2025/0369563 A1
(43) Pub. Date: Dec. 4, 2025

(54) Elevation Platform Assembly

(71) Applicant: Brenda Williamson, Morris Plains, NJ (US)

(72) Inventor: Brenda Williamson, Morris Plains, NJ (US)

(73) Assignee: Brenda Williamson, Morris Plains, NJ (US)

(21) Appl. No.: 19/224,018

(22) Filed: May 30, 2025

Related U.S. Application Data
(60) Provisional application No. 63/655,029, filed on Jun. 2, 2024.

(51) Int. Cl. F16M 13/02; F16M 11/04

(52) U.S. Cl. CPC F16M 13/022; F16M 11/046

(57) ABSTRACT

An elevation platform assembly comprising a platform having a top surface and a bottom surface, the platform configured to couple to a device; a base having a top surface and a bottom surface, the base configured to couple to a furniture part; and a post coupled to a top surface of the base and to a bottom surface of the platform, wherein the post comprises a length to elevate the platform above the base to position the device a suitable height above the furniture part.

The disclosure is directed to an elevation platform (or “rest” or “perch”) for positioning a device, such as a fan for air circulation, in a suitable position.

### BACKGROUND

Rooms in college dormitories, senior housing, etc., may lack air conditioning and may often have inadequate air circulation. Use of fans is common in such instances to improve air circulation and for cooling. However, it may be difficult to place a commercially available fan in an optimal position, especially for sleeping or when otherwise being positioned on a bed. This is especially true for a raised bed or a top bed of a bunk bed.

For example, many US colleges and universities start fall semester in August. Dorm rooms generally do not have air conditioning, and many dorm beds are raised higher off the ground to allow for storage underneath. Therefore, students may need a fan to direct air toward them to allow them to sleep at night. Typical air fans cannot be positioned to direct air to a person on such a dorm bed. Dorm rooms may be too small to accommodate a large tower fan, and there generally is no suitable place to position a small fan.

Accordingly, desired is an apparatus to couple a small fan thereto, the apparatus configured to allow the fan to be placed in an optimal position for use. For example, an apparatus configured to place a fan in an optimal position to direct air to a person on a bed. Also desired is such an apparatus that may be removably attached to an item, such as a bed frame, without causing any damage.

### SUMMARY

Accordingly, disclosed is an elevation platform assembly comprising a platform having a top surface and a bottom surface, the platform configured to couple to a device; a base having a top surface and a bottom surface, the base configured to couple to a part, for example a furniture part or a shelf; and a post coupled to a top surface of the base and to a bottom surface of the platform, wherein the post comprises a length to elevate the platform above the base to position the device a suitable height above the part.

In some embodiments, a furniture part may be a bed frame, a tabletop, a part of a chair, or a shelf. A device may be an electric device such as a circulating fan to provide air circulation and/or cooling. In some embodiments, an elevation platform assembly may be configured to be adjustably and removably coupled to a furniture part.

### BRIEF DESCRIPTION OF THE DRAWINGS

This disclosure is illustrated by way of example and not by way of limitation in the accompanying FIGURES. For simplicity and clarity of illustration, features illustrated in the figures are not necessarily drawn to scale. For example, the dimensions of some features may be exaggerated relative to other features for clarity. Further, where considered appropriate, reference labels have been repeated among the FIGURES to indicate corresponding or analogous elements.

FIG. 1A and FIG. 1B show a fan positioned on an elevation platform assembly coupled to a bed frame, according to some embodiments.

FIG. 1C and FIG. 1D provide views of an elevation platform assembly, according to some embodiments.

FIG. 1E provides views of components of an elevation platform assembly, according to some embodiments.

### DETAILED DESCRIPTION

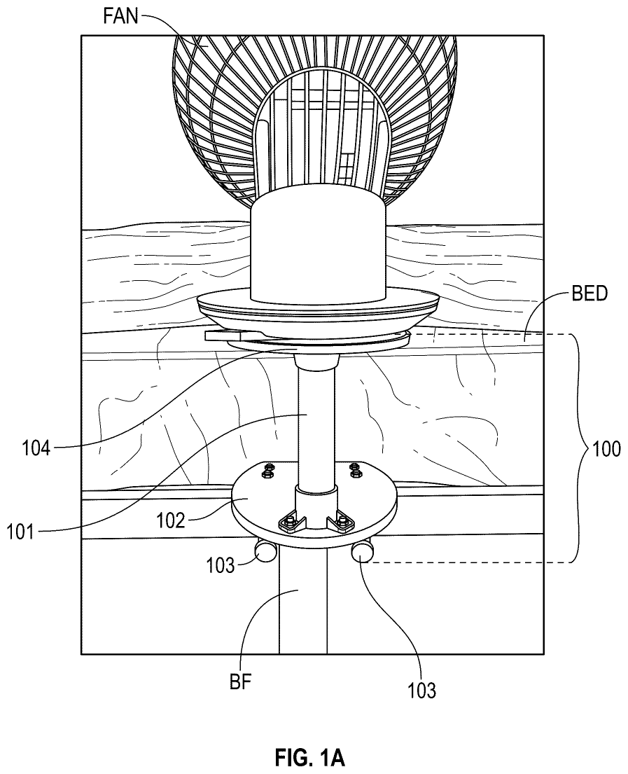

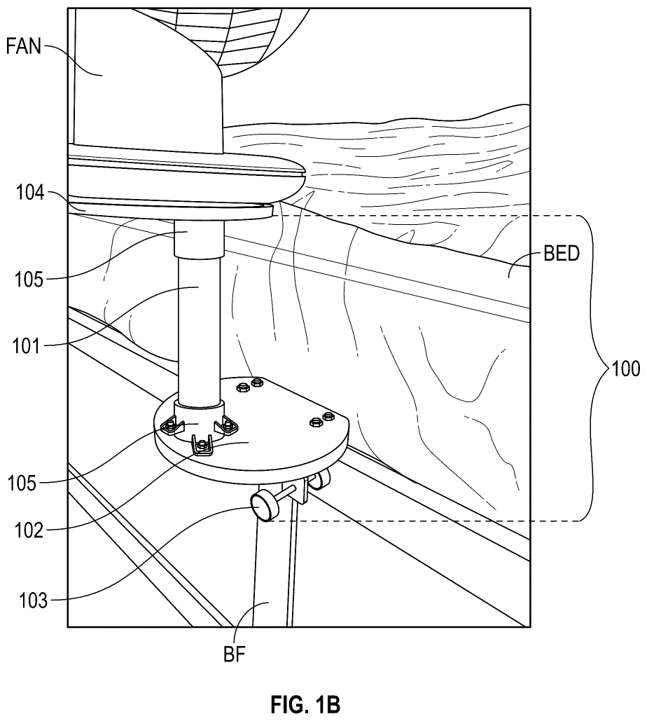

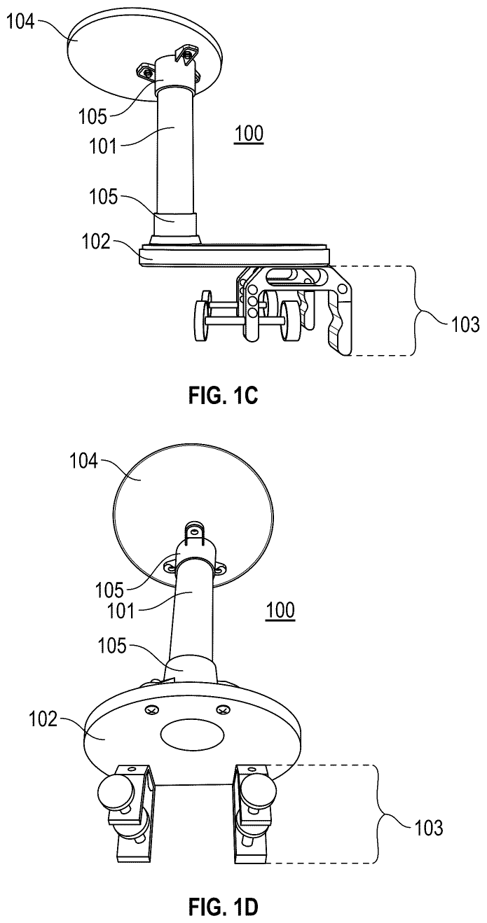

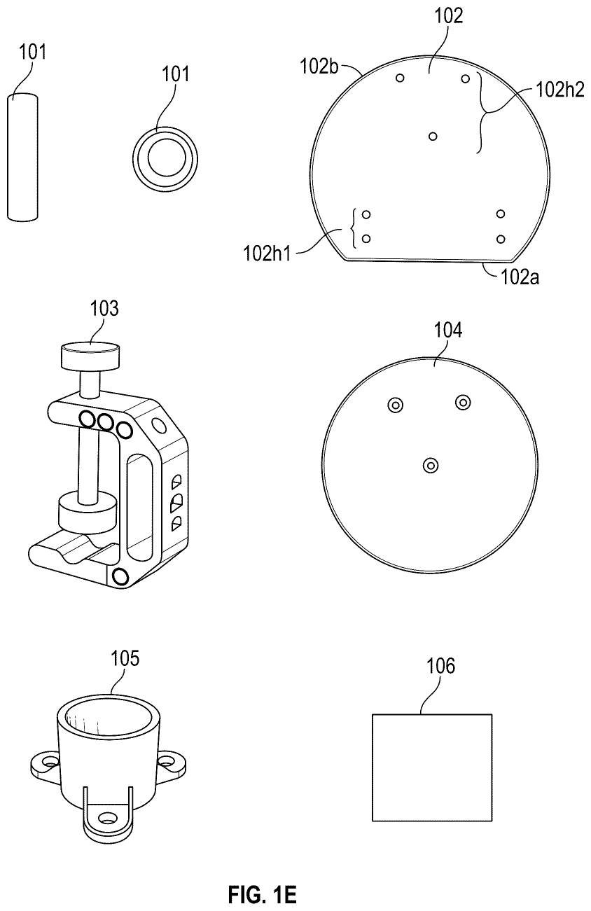

FIG. 1A and FIG. 1B provide views of commercially available air circulation fan FAN (WOOZOO fan), positioned on elevation platform assembly 100, according to some embodiments. FAN is positioned on substantially disc-shaped platform 104, which itself is elevated from base 102 with post 101. Base 102 comprises an irregular disc-like shape. Post 101 is coupled to base 102, and base 102 is coupled to bedframe BF with C-clamps 103. Assembly 100 comprises a suitable height for FAN to circulate air over a top of bed BED. FAN may be coupled to a top surface of platform 104 with a VELCRO (Velcro, or hook and loop) coupling (not visible).

FIG. 1C and FIG. 1D show side and bottom perspective views of elevation platform assembly 100, respectively, according to some embodiments. C-clamps 103 are coupled to a bottom surface of and towards a first end of base 102. Post 101 is coupled to a top surface of and towards a second end of base 102. Post 101 is coupled to a bottom surface of platform 104 and to a top surface of base 102 with table caps 105. Table caps 105 are coupled to base 102 and platform 104 with metal screws.

FIG. 1E shows views of components of elevation platform assembly 100, according to some embodiments. Base 102 is shown in a top view. Base second end 102b comprises a rounded edge, configured to allow for freedom of movement of an electric cord, and/or for easier access to C-clamps 103. Base second end 102b contains pre-drilled holes 102h2 to receive screws to fasten table cap 105 thereto. Base first end 102a contains pre-drilled holes 102h1 to receive screws to fasten C-clamps 103 thereto. Base first end 102a comprises a substantially straight edge, so as to generally align with a bed or bedframe. Post 101 is a PVC furniture grade pipe, shown in side (lengthwise) and top views. A bottom surface of disc-shaped platform 104 comprises pre-drilled holes to receive screws to fasten table cap 105 thereto. A top surface of platform 104 may be coupled to Velcro coupling 106, configured to couple to an appliance having one or more Velcro couplings to couple to 106.

In some embodiments, a base may be coupled to one or more attachment features configured to removably attach or couple an elevation platform assembly to a piece of furniture or a furniture part, for example to a table top, a part of a chair, a bedframe, a shelf, and the like. A base first end may be coupled to one or more attachment features. Removable coupling allows for moving an assembly from residence to residence or room to room. In certain embodiments, a present assembly may be removably coupled to a bedframe of an elevated bed or a bunk bed. Removable attachment features may comprise clamps, for example C-clamps. C-clamps may also adjustably couple a present assembly to a furniture part, for instance adjustable couple to a certain part of a piece of furniture.

In some embodiments, a platform may comprise a disc shape, a square shape, a rectangular shape, an oval shape, etc. In some embodiments, a base may likewise comprise an irregular disc shape, a disc shape, a square shape, a rectangle shape, etc. In certain embodiments, a platform may comprise a disc-like shape and a base may comprise an irregular disc-like shape. A base first end may be coupled to one or more attachment features as mentioned above, for example one or more C-clamps. A base first end may comprise a straight edge. In some embodiments, a base second end may comprise rounded or beveled edges. Rounded or beveled edges may provide for more freedom for a device electric cord, and/or provide more freedom for one to reach and adjust an attachment feature coupled to a base bottom surface.

A platform may be elevated from a base with a post. A post may comprise a cylinder-like shape or a “pipe” shape. In other embodiments, a post may comprise a square or a rectangular-like shape. A post may be coupled to a platform bottom surface and to a base top surface. A post may be coupled to a platform bottom surface towards or at a center of the platform. A post may be coupled to a platform bottom surface towards an edge closest to a base second end. A post may be coupled to a base top surface towards or at a base second end. A post may be coupled to a base top surface and to a platform bottom surface with a table cap.

A post comprises a length (height) configured to provide a suitable vertical position of a device, for example a circulating electric fan. A post length may for example be from any of about 3.0 inches, about 3.5 inches, about 4.0 inches, or about 4.5 inches, to any of about 5.0 inches, about 5.5 inches, about 6.0 inches, about 6.5 inches, about 7.0 inches, about 7.5 inches, about 8.0 inches, about 8.5 inches, about 9.0 inches, about 9.5 inches, about 10.0 inches, about 10.5 inches, about 11.0 inches, about 11.5 inches, or about 12.0 inches, or more.

In some embodiments, a post may comprise a fixed length. In other embodiments, a post may comprise a telescopic, i.e. adjustable feature, wherein one may adjust a height of a platform once an assembly is installed to a furniture part.

A base may comprise a length from a first end to a second end of from any of about 4.0 inches, about 5.0 inches, or about 6.0 inches to any of about 7.0 inches, about 8.0 inches, about 9.0 inches, about 10.0 inches, about 11.0 inches, about 12.0 inches, about 13.0 inches, or more. A base may comprise a width of from any of about 3.0 inches, about 4.0 inches, or about 5.0 inches to any of about 6.0 inches, about 7.0 inches, about 8.0 inches, about 9.0 inches, about 10.0 inches, or more.

In general, a post may be perpendicular to both a base and a platform. A base and a platform may be configured to be level and parallel to each other. In some embodiments, a device may be an electric air circulation fan. In other embodiments, a device may be a laptop computer, a smartphone holder, a book holder, etc. In some embodiments, a platform top surface may have affixed thereto a VELCRO (Velcro or hook and loop fastener) piece, and a device may have affixed thereto a complimentary Velcro piece in order to removably affix a device to a platform.

In some embodiments, clamps may be commercially available C-clamps, for example aluminum clamps generally used for photography applications. A base, a platform, and a post may each comprise one or more of wood, a metal, a thermoplastic, or a wood/thermoplastic composite. Thermoplastics include for example one or more of a polyolefin, a polyester, an elastomer, a polyamide, a polycarbonate, an acrylate, a polystyrene, polyvinylchloride (PVC), mixtures thereof or copolymers thereof. Thermoplastics may also comprise an engineering thermoplastic selected from one or more polyamides, polyesters, polycarbonates, acrylonitrile-butadiene-styrene, polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides, polyacetals, copolymers thereof, and blends thereof.

In some embodiments, a platform, base, and post assembly may comprise a unitary molded part. In other embodiments, a platform/base/post assembly may comprise 2 or more individual parts coupled together. Parts may be prepared for example via thermoplastic injection molding or 3D printing techniques.

In some embodiments, a post may be a rigid part as shown in the figures. In other embodiments, it may be a flexible part, thereby allowing a platform to be tilted in any direction. Such a flexible part may comprise a coiled metal hose or tubing, e.g. a “gooseneck” pipe, such as is used for example in adjustable desk lamps.

In some embodiments, a base may comprise an opening, for instance an annular or a slot-shaped opening, configured to receive and have passed there through an electric wire for a device.

In some embodiments, a present assembly may be configured to allow a fan to be positioned a few inches away from a bed frame and raised up in a fashion to allow a face of the fan to direct air over a top of the mattress and bedding. A present assembly may be configured so as not to restrict a full rotational oscillating motion of a fan.

The terms “coupled” or “connected” may mean that an element is “attached to” or “associated with” another element. Coupled or connected may mean directly coupled or coupled through one or more other elements. An element may be coupled to an element through two or more other elements in a sequential manner or a non-sequential manner. The term “via” in reference to “via an element” may mean “through” or “by” an element. Coupled or connected or “associated with” may also mean elements not directly or indirectly attached, but that they “go together” in that one may function together with the other. A term “removably coupled” may mean parts may be attached, removed, and re-attached to a same or a different part a plurality of times.

The term “towards” in reference to a of point of attachment, may mean at exactly that location or point or, alternatively, may mean closer to that point than to another distinct point, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, ±6%, ±7%, ±8%, ±9%, or ±10%. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, ±6%, ±7%, ±8%, ±9%, or ±10% of the definition; for example the term “substantially perpendicular” may mean the 90° perpendicular angle may mean “about 90°”. The term “generally” may be equivalent to “substantially”.

Features described in connection with one embodiment of the disclosure may be used in conjunction with other embodiments, even if not explicitly stated.

Embodiments of the disclosure include any and all parts and/or portions of the embodiments, claims, description and FIGURES. Embodiments of the disclosure also include any and all combinations and/or sub-combinations of embodiments.

1. An elevation device platform assembly comprising
a platform having a top surface and a bottom surface, the platform configured to couple to a device;
a base having a top surface and a bottom surface, the base configured to couple to a furniture part; and
a post coupled to a top surface of the base and to a bottom surface of the platform,
wherein
the post comprises a length to elevate the platform above the base to position the device a suitable height above the furniture part.

2. The elevation platform assembly according to claim 1, wherein the base is coupled to one or more clamps configured to adjustably and removably couple the base to the furniture part.

3. The elevation platform assembly according to claim 1, wherein the platform top surface comprises an attachment feature configured to removably affix the device thereto.

4. The elevation platform assembly according to claim 1, wherein the platform top surface comprises one or more hook and loop couplings configured to removably affix the device to the platform top surface.

5. The elevation platform assembly according to claim 2, wherein the one or more clamps are coupled to the base bottom surface towards or at a base first end.

6. The elevation platform assembly according to claim 1, wherein the post is coupled to the base top surface towards or at a base second end.

7. The elevation platform assembly according to claim 1, wherein the post is coupled to the platform bottom surface and to the base top surface with table caps.

8. The elevation platform assembly according to claim 1, wherein the post is coupled to the platform bottom surface towards or at a center of the platform.

9. The elevation platform assembly according to claim 1, wherein the post is coupled to the platform bottom surface towards a platform edge closest to a base second end.

10. The elevation platform assembly according to claim 1, wherein a base second end comprises rounded or beveled edges.

11. The elevation platform assembly according to claim 1, wherein a base first end comprises a substantially straight edge.

12. The elevation platform assembly according to claim 1, wherein the device is an electric air circulation fan.

13. The elevation platform assembly according to claim 1, wherein the platform comprises a disc-like shape.

14. The elevation platform assembly according to claim 1, wherein the base comprises an irregular disc-like shape.

15. The elevation platform assembly according to claim 1, wherein the post comprises a length of from about 3.0 inches to about 12.0 inches.

16. The elevation platform assembly according to claim 1, wherein the base comprises a length from a first end to a second end of from about 4.0 inches to about 13.0 inches, and width of from about 3.0 inches to about 10.0 inches.

17. The elevation platform assembly according to claim 1, wherein the platform and base are parallel to each other and are each perpendicular to the post.

18. The elevation platform assembly according to claim 1, comprising a thermoplastic, a metal, wood, or a wood/thermoplastic composite.

19. The elevation platform assembly according to claim 1, comprising a molded thermoplastic part.

20. The elevation platform assembly according to claim 1, wherein the post is rigid or is flexible.
